(19) United States
(12) Patent Application Publication
(10) Pub. No.: US 2012/0313579 A1
(43) Pub. Date: Dec. 13, 2012

(54) CONTACTLESS POWER SUPPLY DEVICE AND CONTACTLESS CHARGING SYSTEM

(76) Inventors: Takaoki Matsumoto, Shiga-ken (JP); Atsushi Isaka, Shiga-ken (JP); Kazuhiro Suzuki, Shiga-ken (JP); Kyohei Kada, Kyoto (JP); Yoshihide Kanakubo, Osaka (JP); Yohei Nagatake, Kanagawa-ken (JP); Kazuyo Ohta, Chiba-ken (JP)

(21) Appl. No.: 13/580,114

(22) PCT Filed: Mar. 7, 2011
(86) PCT No.: PCT/JP2011/055190

§ 371 Date: Aug. 20, 2012

(30) Foreign Application Priority Data
Mar. 26, 2010 (JP) 2010-073810

(51) Int. Cl. H02J 7/00

(52) U.S. Cl. 320/108

(57) ABSTRACT

A primary-side controller (12) retains a reference current value corresponding to an input current measured in the previous detection cycle by an input current measurement unit (11), in a charging state. The primary-side controller (12) adds the retained reference current value and a predetermined current value, and generates a first threshold value. When the input current measured by the input current measurement unit (11) in the latest detection cycle is equal to or greater than the first threshold value, a determination is made that a foreign metal is present in the vicinity of a first coil (L1).

### TECHNICAL FIELD

The present invention relates to a contactless power supply device that uses electromagnetic induction to perform power transmission between devices in a contactless manner and to a contactless power charging system that includes a contactless power supply device.

### BACKGROUND ART

Contactless power supply devices have recently become widely known as devices that can charge, in a contactless manner, rechargeable cells (batteries) used in portable devices such as cellular phones and digital cameras. Such a portable device and charger applicable to the portable device each include a coil used for the transfer of charging power. Electromagnetic induction occurs between the two coils and thereby transfers AC power from the charger to the portable device. The portable device converts the AC power to DC power to charge the rechargeable battery, which is the power supply of the portable device.

The employment of such contactless charging allows for the elimination of connection terminals that electrically connect the charger and the portable device. However, a metal foreign object such as a clip or coin may be present between the coils. For example, when a coil is generating high-frequency magnetic flux, overcurrent resulting from leakage flux may flow to the metal foreign object located in the vicinity of the coil, heat the metal foreign object, and affect the contactless power supply device. Thus, there has been discussion of a means for detecting a metal foreign object that is located in the vicinity of a coil (for example, patent document 1).

A method for determining whether or not a metal foreign object is present based on a current value will now be described. An experiment was conducted to measure the value of the current flowing through a coil or the like in a state in which a metal foreign object is arranged in the vicinity of the coil. The current value obtained when a metal foreign object is located in the vicinity of the coil is set in advance as a threshold for a contactless power supply device. When a current value exceeding the threshold is measured, the contactless power supply device determines that a metal foreign object is present and displays a warning or stops the charging.

### PRIOR ART DOCUMENT

### Patent Document

Patent Document 1: Japanese Laid-Open Patent Publication No. 2008-206231

### SUMMARY OF THE INVENTION

### Problems that are to be Solved by the Invention

There are various types of metal foreign objects that differ in shape, material, and size. Further, a metal foreign object may be present under various conditions (temperature, distance from coil to foreign object, and the like). A contactless power supply device is formed by many elements (diodes, capacitors, and the like). Even when using elements of the same type, the performance of each element may be varied during the manufacturing process. This results in performance variations between contactless power supply devices. Thus, when the set threshold is the same for any condition, there may be cases in which a metal foreign object can be detected and cases in which a metal foreign object cannot be detected. To prevent a situation in which a metal foreign object cannot be detected, the threshold may be set to a relatively low value. In such a case, an erroneous detection of the presence of a metal foreign object may occur even though one is not present.

Accordingly, it is an object of the present invention to provide a contactless power supply device and a contactless charge system that detects metal even when there are variations in the performance and metal foreign object.

### Means for Solving the Problem

To achieve the above object, one aspect of the present invention provides a contactless power supply device that supplies power in a contactless manner from a primary coil to a secondary coil. The contactless power supply device includes the primary coil supplied with AC current to generate alternating flux. An input current measurement unit measures a current value of an input current of the primary coil in a charging state during which the alternating flux generated by the primary coil intersects the secondary coil. A determination unit determines that a metal foreign object has been detected when a most recent input current measured by the input current measurement unit in a most recent detection cycle is greater than or equal to a threshold obtained by adding a predetermined current value to a reference current value, which corresponds to a current value of an input current measured by the input current measurement unit in a previous detection cycle.

In one example, the threshold is a first threshold. In a standby state during which the alternating flux generated by the primary coil does not intersect the secondary coil or an authentication state for determining whether or not the alternating flux generated by the primary coil intersects the secondary coil, the determination unit determines detection of a metal foreign object when a most recent current value measured by the input current measurement unit is greater than or equal to a predetermined second threshold. In the charging state during which the alternating flux generated by the primary coil intersects the secondary coil, the determination unit determines detection of a metal foreign object when the most recent current value measured by the input current measurement unit is greater than or equal to the first threshold.

In one example, the threshold is a first threshold. The determination unit determines detection of a metal foreign object when the most recent current measured by the input current measurement unit is greater than or equal to the first threshold or when the most recent current value is greater than or equal to a predetermined second threshold.

In one example, the determination unit updates the reference current value in fixed cycles.

In one example, the input current measurement unit includes a first measurement resistor, through which the input current flows when the alternating flux generated by the primary coil does not intersect the secondary coil, and a second measurement resistor, through which the input current flows when the alternating flux generated by the primary coil intersects the secondary coil. The first and second measurement resistors have difference resistances.

In one example, the determination unit holds the current value of the input current measured in a detection cycle ahead by one cycle from the present cycle as the reference current value. When the most recent input current is less than the threshold, the determination unit holds the most recent input current as a new reference current value to update the reference current value.

A further aspect of the present invention provides a contactless charging system provided with a contactless power supply device, which includes a primary coil supplied with AC current to generate alternating flux, and a contactless power reception device, which includes a secondary coil that intersects the alternating flux generated by the primary coil, a conversion unit that converts AC current supplied from the primary coil via the secondary coil into DC current, and a load supplied with the DC current converted by the conversion unit. The contactless power supply device includes an input current measurement unit that measures a current value of an input current of the primary coil in a charging state during which the alternating flux generated by the primary coil intersects the secondary coil. A determination unit determines that a metal foreign object has been detected when a most recent input current measured by the input current measurement unit in a most recent detection cycle is greater than or equal to a threshold obtained by adding a predetermined current value to a reference current value, which corresponds to a current value of an input current measured by the input current measurement unit in a previous detection cycle. The contactless power reception device includes a load current control unit that constant-current-controls a load current converted to DC current by the conversion unit, a charging current control unit that supplies the load with the load current as charging current, and a power reception side measurement unit that measures a current value of the charging current. The load current control unit is configured to constant-current-control the load current so that a current value of the load current becomes lower than the current value of the charging current. The determination unit performs a determination when the load current control unit is executing constant current control.

In one example, when the charging current to the load becomes lower than the load current, the contactless power reception device transmits a signal for notification of such a situation, and the contactless power supply device varies the predetermined current value when receiving the signal.

### BRIEF DESCRIPTION OF THE DRAWINGS

FIG. 1 is a block diagram showing a contactless charging system;

FIGS. 2A and 2B are schematic diagrams showing situations in which a metal foreign object is present in the vicinity of a primary coil;

FIG. 3A is a timing chart showing a current value difference and a first threshold; and

FIG. 3B is a timing chart showing the comparison of the current value and a second threshold.

### EMBODIMENTS OF THE INVENTION

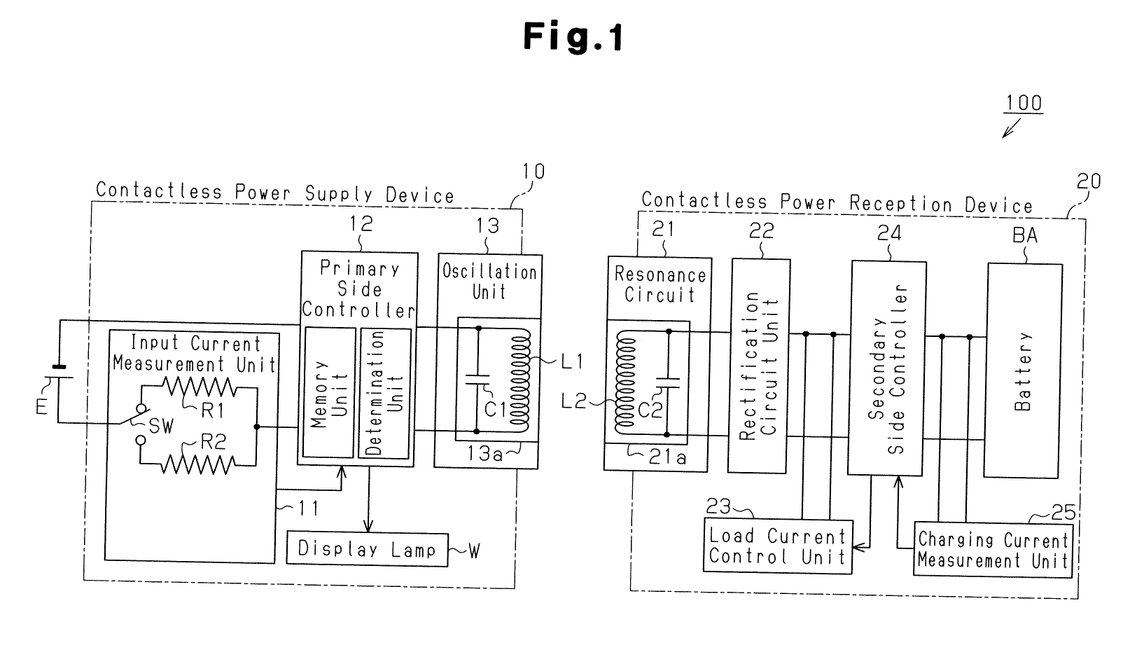

A contactless charge system according to one embodiment of the present invention will now be described. As shown in FIG. 1, a contactless charge system 100 of the embodiment includes a contactless power supply device 10 and a contactless power reception device 20.

The contactless power supply device 10 will first be described.

The contactless power supply device 10 includes an input current measurement unit 11, which measures input current supplied from an external power supply E, a primary side controller (determination unit) 12, which executes various types of controls related to the input and output of the input current, and an oscillation unit 13, which generates alternating flux based on the input current.

The input current measurement unit 11 receives input current supplied from the external power supply E, which is connected to the contactless power supply device 10, and measures the value of the current. The input current measurement unit 11 is connected to the primary side controller 12 and supplies the input current to the primary side controller 12. Further, the input current measurement unit 11 notifies the primary side controller 12 of the measured input current. The current value of the input current measured by the input current measurement unit 11 corresponds to the input current supplied to the oscillation unit 13. The input current measurement by the input current measurement unit 11 may be referred to as an input current of a primary coil. The input current measurement unit 11 includes a plurality of resistors R1 and R2, which are connected in parallel and have different resistances. When measuring the input current from the DC power supply E, a switching element SW is switched so that the input current flows to one of the plurality of resistors. The input current measurement unit 11 actuates the switching element SW in accordance with a control signal from the primary side controller 12 and switches the resistor R1 and the resistor R2. The resistor R1 may be referred to a resistor for a standby state or an authentication state. The resistor R2 may be referred to as a resistor for a charging state.

The primary side controller 12 may be a microcomputer including a central processing unit (CPU), which serves as a determination unit, and a memory device (non-volatile memory (ROM), volatile memory (RAM), and the like), which serves as a memory unit. The primary side controller 12 controls various operations, such as the oscillation of an LC circuit in the oscillation unit 13, in accordance with various types of data and programs stored in the memory device. The primary side controller 12 of the present embodiment may demodulate electromagnetic induction type data communication (for example, various types of response signals that will be described later) from the contactless power reception device 20 and control the oscillation of the oscillation unit 13 in accordance with the demodulated signal. The ROM stores, in advance, various types of thresholds that will be described later and various types of parameters required to demodulate the wireless communication signals transmitted from the contactless power reception device 20 and analyze the demodulated signal. The primary side controller 12 is one example of a memory unit and a determination unit.

The oscillation unit 13 includes a primary side LC circuit (resonance circuit) 13a in which a primary coil L1 and a resonance capacitor C1 are connected in parallel. The input current supplied from the primary side controller 12 is supplied to the primary side LC circuit 13a. When the input current flows to the primary side LC circuit 13a, the primary side LC circuit 13a functions to generate AC current that flows to the primary coil L1, and the primary coil L1 generates alternating flux having a predetermined frequency.

Next, the contactless power reception device 20 will be described.

The contactless power reception device 20 includes a resonance circuit unit 21, which receives alternating flux from the contactless power supply device 10, a rectification circuit unit 22, which serves as a conversion unit that converts AC current into DC current, a load current control unit 23, which constant-current-controls the DC current from the rectification circuit unit 22 to generate load current, a secondary side controller (charging current control unit) 24, which supplies the charging current to a load, a charging current measurement unit 25, which measures the current value of the charging current, and a battery BA, which serves as the load that is supplied with the charging current (power) from the secondary side controller 24.

The resonance circuit unit 21 includes a secondary side resonance circuit (LC circuit) 21a in which a secondary coil L2 and capacitor C2 are connected in parallel. The secondary side resonance circuit 21a outputs AC current, which is induced to the secondary coil L2 by the alternating magnetic field of the primary coil L1. The resonance circuit unit 21 is connected to the rectification circuit unit 22 and supplies the AC current to the rectification circuit unit 22.

In the present embodiment, the capacitor C2 of the secondary side resonance circuit 21a is selected so that the secondary coil L2 is magnetically coupled in a favorable manner to the primary coil L1. Since the secondary coil L2 is magnetically coupled in a favorable manner to the primary coil L1, the contactless power reception device 20 can efficiently receive a large amount of power and supply the battery BA with a large amount of DC power (current).

The rectification circuit unit 22 is supplied with power (voltage) generated between the terminals of the secondary coil L2 in the resonance circuit unit 21. The rectification circuit unit 22 includes a rectification diode, which is connected in series to the resonance circuit unit 21, and a smoothing capacitor, which smoothes the power rectified by the rectification diode, and forms a so-called half-wave rectification circuit that converts the AC current supplied from the rectification diode into DC current. Further, the rectification circuit unit 22 is connected to the load current control unit 23 and supplies the converted DC current to the load current control unit 23. The configuration of the rectification circuit unit 22 is just one example of a rectification circuit that converts AC current into DC current. The rectification circuit unit 22 is not limited to such a configuration and may be configured as a full-wave rectification using a diode bridge or any other known rectification circuit.

The load current control unit 23 generates load current from the DC current supplied from the rectification circuit unit 22. The load current control unit 23, which is configured so that it can perform constant current control, performs constant current control so that the load current is adjusted to a predetermined load current. The load current control unit 23 is configured so that the current value of the load current can be changed. The load current control unit 23 changes the current value of the load current in accordance with a control signal provided from the secondary side controller 24.

The secondary side controller 24 may be a microcomputer including a central processing unit (CPU) and a memory device (ROM, RAM, and the like). The secondary side controller 24 determines the state of charge of the battery BA in addition to executing various controls, such as charged amount control, in accordance with various types of data and programs stored in the memory device. The secondary side controller 24 of the present embodiment can generate wireless communication signals provided to the contactless power supply device 10 in accordance with the charged amount of the battery BA. The ROM stores, in advance, various types of information required for charged amount control, such as when determining the charged amount of the battery BA, and various types of parameters required to generate wireless communication signals exchanged with the contactless power reception device 20 and perform modulation based on the communication signals. The secondary side controller 24 is one example of a charging current control unit.

Further, the secondary side controller 24, which is connected to the positive electrode and negative electrode of the battery BA, is supplied with drive power from the battery BA. The secondary side controller 24 can detect the charged amount of the battery BA from the voltage across the terminals of the battery BA or the like. The secondary side controller 24 performs control that starts or stops the supply of power to the battery BA based on the DC voltage of the rectification circuit unit 22. More specifically, the secondary side controller 24 controls the supply of power to the battery BA with the DC voltage converted by the rectification circuit unit 22. The secondary side controller 24 determines whether or not to output charging current in accordance with the charged amount of the battery BA. In a non-restrictive example, when the voltage across the terminals of the battery BA is less than a charged amount determination threshold that is set in advance, the secondary side controller 24 determines that the charging of the battery BA is preferable and supplies the battery BA with charging current. On the other hand, when the voltage across the terminals of the battery BA is greater than the charged amount determination threshold, the secondary side controller 24 determines that there is no need to charge the battery BA and does not supply the battery BA with charging current.

The charging current measurement unit 25 measures the current value of the charging current supplied to the battery BA from the secondary side controller 24. The charging current measurement unit 25 is connected to the secondary side controller 24 and notifies the secondary side controller 24 of the measured current value.

The charge control of the battery BA will now be described. First, the control by the contactless power supply device 10 will be described.

In a state other than a charging state (e.g., standby state), the primary side controller 12 supplies the oscillation unit 13 with input current that is decreased from the input current for the charging state. In a non-restrictive example, during a non-charging state, the primary side controller 12 is intermittently actuated and supplies the oscillation unit 13 with input current of a predetermined current value that is less than the current value for a charging state. The alternating flux output by the oscillation unit 13 in a non-charging state may be referred to as a device detection signal.

In a standby state, the primary side controller 12 detects whether or not a peak voltage in the primary coil voltage has exceeded a threshold to determine the arrangement of the contactless power reception device 20. The threshold corresponds to the peak voltage of the primary coil voltage when the contactless power reception device 20 is arranged at a position where it can be magnetically coupled to the contactless power supply device 10. For example, the contactless power reception device 20, when arranged at a position where it can be magnetically coupled to the contactless power supply device 10, outputs a first response signal in response to the alternating flux that serves as the device detection signal. The first response signal changes the primary coil voltage so that the peak voltage of the primary coil voltage in the contactless power supply device 10 exceeds the threshold.

When the peak voltage of the primary coil voltage does not exceed the threshold, the primary side controller 12 determines that the contactless power reception device 20 is not arranged at a position where it can be magnetically coupled to the contactless power supply device 10 and maintains the contactless power supply device 10 in the standby state.

On the other hand, when the peak voltage of the primary coil voltage exceeds the threshold, that is, when the first response signal is received from the contactless power reception device 20, the primary side controller 12 determines that the contactless power reception device 20 is arranged at a position where it can be magnetically coupled to the contactless power supply device 10 and that the contactless power supply device 10 is in an authentication state. Further, the primary side controller 12 starts authentication of the contactless power reception device 20. More specifically, when receiving the first response signal, the primary side controller 12 outputs a charging preparation check signal to check whether or not charging preparations have been made in the device (contactless power reception device 20) arranged at a position where it can be magnetically coupled to the contactless power supply device 10. When the primary side controller 12 receives a second response signal, which indicates that charging preparations have been made in response to the charging preparation check signal, the primary side controller 12 outputs an ID confirmation signal, which indicates the machine type or the like. Further, when the primary side controller 12 receives a third response signal, which indicates that the ID has been confirmed in response to the ID confirmation signal, the primary side controller 12 ends the authentication and starts the charging.

When the secondary side controller 24 receives a device detection signal in a non-charging state, the secondary side controller 24 outputs the first response signal and notifies the primary side controller 12 that the contactless power reception device 20 is arranged at a position where the alternating flux output from the primary coil L1 of the contactless power supply device 10 intersects the secondary coil L2. Further, when the secondary side controller 24 receives the charge preparation check signal in a non-charging state, the secondary side controller 24 checks the charged amount of the battery BA and determines whether the battery BA is in a chargeable state. When in the chargeable state, the secondary side controller 24 outputs the second response signal indicating that charging preparations have been made. When the secondary side controller 24 receives the ID confirmation signal in a non-charging state, the secondary side controller 24 confirms the ID included in the ID confirmation signal. When the ID can be confirmed, the secondary side controller 24 outputs the third response signal.

The arrangement determination and authentication procedures performed by the two devices are examples, and one skilled in the art will understand that the arrangement determination and authentication can be performed through other procedures.

When the primary side controller 12 determines that the contactless power supply device 10 is in an authentication state, the primary side controller 12 is actuated so that current value of the input current becomes less than the current value for a charging state. More specifically, the primary side controller 12 supplies the oscillation unit 13 with input current having a predetermined current value, which is less than the current value for a charging state.

When the authentication ends normally, the primary side controller 12 determines that charging can be performed and maximizes the output of the input current supplied to the oscillation unit 13. Then, AC current corresponding to the input current flows to the primary coil L1, and the primary coil L1 generates alternating flux. When in the charging state, the input current measurement unit 11 switches from the standby state or authentication state resistor R1 to the charging state resistor R2 to measure the current value of the input current. The resistance of the charging state resistor R2 is less than the resistance of the standby state or authentication state resistor R1. This reduces power loss during a charging state.

A charging state control performed by the contactless power reception device will now be described.

When the secondary coil L2 intersects the alternating flux, AC current is supplied from the secondary coil L2 to the rectification circuit unit 22. The rectification circuit unit 22 converts the supplied AC current into DC current and outputs the DC current. When the load current control unit 23 receives a charging state notification from the secondary side controller 24, the load current control unit 23 constant-current-controls the load current supplied to the secondary side controller 24. When the secondary side controller is supplied with the load current from the load current control unit 23, the secondary side controller 24 detects the charged amount of the battery BA and outputs charging current in accordance with the charged amount.

In the charging state, the charging current measurement unit 25 measures the current value of the charging current supplied to the battery BA and notifies the secondary side controller 24 of the measurement result. Further, the secondary side controller 24 provides the load current control unit 23 with a control signal so that the current value of the charging current in the notification from the charging current measurement unit 25 does not become less than the current value of the charging current. The load current control unit 23 controls the current value of the load current in accordance with the control signal from the secondary side controller 24 so that the current value of the load current is less than the current value of the charging current.

As a result, even when the charging of the battery BA advances, the voltage of the battery BA increases, and the current value of the charging current becomes low, the current value of the load current can be adjusted accordingly to be less than the charging current. Thus, charging current can be continuously supplied until the battery BA becomes fully charged.

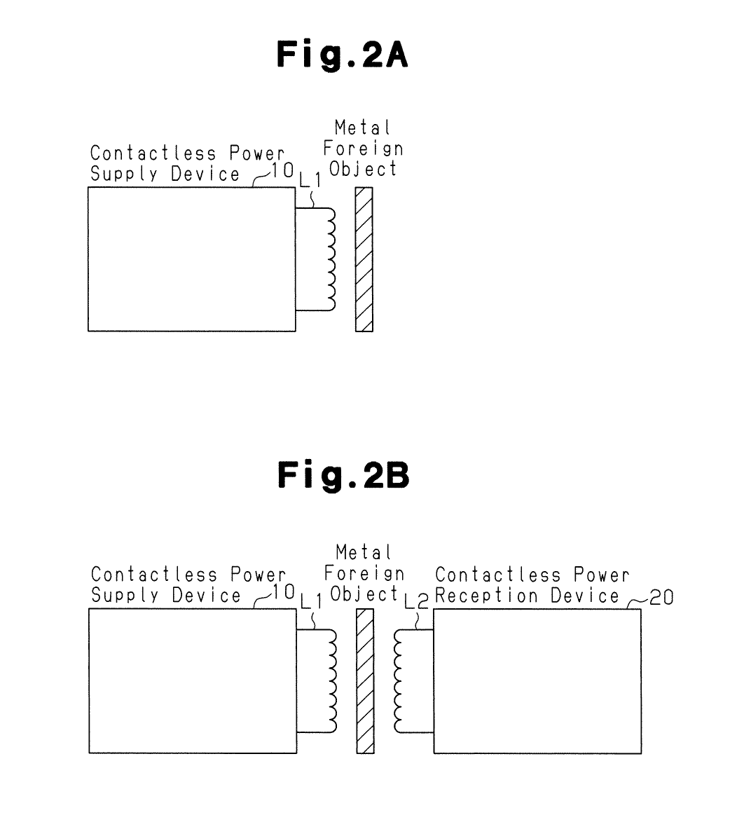

Further, when a metal foreign object, such as a clip, ring, or coil, is present in the vicinity of the primary coil L1 (state such as that shown in FIGS. 2A and 2B), the contactless power supply device 10 of the present embodiment can detect the metal foreign object to prevent overcurrent from heating the metal foreign object. In the range that is within the reach of the alternating flux from the primary coil L1, the vicinity of the primary coil L1 is defined as the distance within which alternating flux heats a metal foreign object during charging. The distance changes in accordance with the current value of the input current, the temperature, the shape of the primary coil L1, the size, shape, and material of the metal foreign object, and the like. Regardless of the relative positions of the primary coil L1 and the metal foreign object, as long as the metal foreign object is closer than the set distance, the metal foreign object is determined as being in the vicinity of the primary coil L1. The control related with metal detection will now be described.

The primary side controller 12 obtains the current value of the input current from the input current measurement unit 11 to the oscillation unit 13 in predetermined detection cycles. The detection cycle is set based on the time required to heat a metal foreign object. In further detail, the detection cycle may vary in accordance with the expected size, type, material, and shape of a metal foreign object; the time required for heating to a temperature at which the occurrence of an abnormality can be anticipated; the shape, size, and material of the primary coil L1; the current value of the input current; and the like.

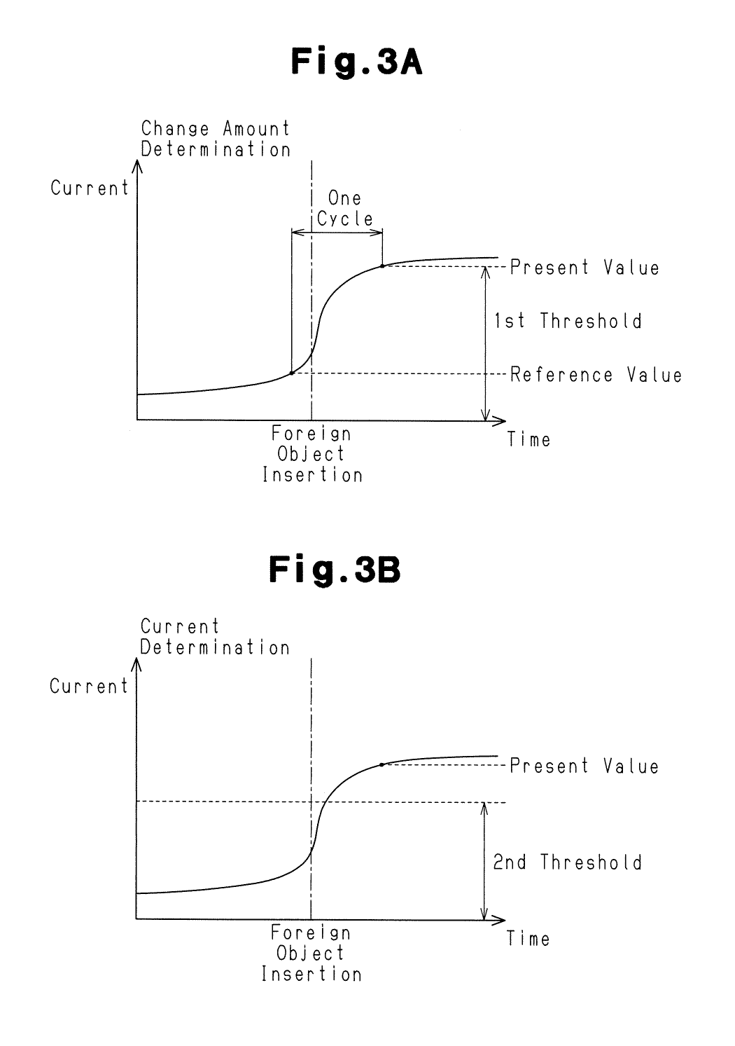

In a charging state, the primary side controller 12 holds a reference current value that was measured in the previous detection cycle by the input current measurement unit 11. The primary side controller 12 adds a predetermined current value I to the held reference current value and generates a first threshold. When a most recent input current measured in the most recent detection cycle by the input current measurement unit 11 during a charging state is greater than or equal to the first threshold, the primary side controller 12 determines that a metal foreign object is present (refer to FIG. 3A). In the illustrated example, the primary side controller 12 holds the current value of the input current measured in the cycle that is one cycle ahead of the present one. The current value I, which is added to the reference current value, is set through experiments and differs in accordance with the expected size, type, material, and shape of a metal foreign object; the heating temperature at which the occurrence of an abnormality can be anticipated; the detection cycle; the shape, size, and material of the primary coil L1; the normal current value of the input current; and the like.

When the most recent input current becomes greater than or equal to the first threshold, this indicates that the input current has been increased by a change amount that is greater than or equal to the current value I during a period from when the primary side controller 12 holds the reference current value to the most recent detection cycle. The increase in the input current provides sufficient support for anticipating the presence of a metal foreign object.

When the most recent input current is less than the first threshold, the primary side controller 12 stores the current value of the input current as a new reference current value in the RAM and updates the reference current value. The reference current value may reflect various factors including time variable factors, such as the present state of the contactless power supply device 10 and the usage environment, and factors unique to the device, such as variations in the components. The reference current value varies in accordance with at least the time variable factors. Thus, the first threshold is a variable value.

Further, when the most recent input current is less than the first threshold, the primary side controller 12 determines whether or not the current value (present value) of the input current is greater than or equal to a predetermined second threshold (refer to FIG. 3B). The second threshold is set through experiments and differs in accordance with the expected size, type, material, and shape of a metal foreign object; the time required to reach the heating temperature at which an abnormality occurs; the shape, size, and material of the primary coil L1; the current value of the input current when a foreign object is present; and the like. In one example, the second threshold is a fixed value.

When the most recent input current is less than the first threshold and the second threshold, the primary side controller 12 determines that a metal foreign object is not present. When the most recent input current is greater than or equal to the first threshold or the second threshold, the primary side controller 12 determines that a metal foreign object is present and stops supplying the input current to the oscillation unit 13. The primary side controller 12 lights a display lamp W to generate a notification indicating the presence of a metal foreign object.

In a standby state or authentication state, the primary side controller 12 determines whether or not the most recent current value of the input current is greater than or equal to the predetermined second threshold for metal foreign object determination (refer to FIG. 3B).

In the charging state, when the current value of the most recent input current is less than the reference current value, the primary side controller 12 sets the most recent current value as a new reference current value. Further, the primary side controller 12 determines the charging state first threshold (more specifically, the current value I added to the reference current value) in accordance with the newly set reference current value. In the charging state, the current value of the input current may change in accordance with the charged amount of the battery BA. More specifically, the current value of the input current is lower when the charged amount of the battery BA is high (close to fully charged state) than when the charged amount of the battery BA is low (charging not advanced). Further, the current value of the input current may increase at a timing at which the current consumption of the contactless power reception device 20 increases (e.g., when the cell phone receives a call or when a backlight is illuminated). In such a case, the difference in the current value of the input current increases between when the held reference current value is measured and when the most recent detection cycle is performed. If the same threshold is used without updating the first threshold when the most recent input current becomes lower than the reference current value, an erroneous detection may occur. Thus, when the current value of the input current input to the primary coil decreases in a charging state, the primary side controller 12 changes the charging state first threshold in accordance with the current value to avoid erroneous detections.

As described above in detail, the present embodiment has the advantages described below.

(1) In a charging state, the primary side controller 12 generates the first threshold by adding a reference current value, which corresponds to the current value of the input current previously measured by the input current measurement unit 11, to a predetermined current value. When the most recent input current measured by the input current measurement unit is greater than or equal to the first threshold, the primary side controller 12 determines that a metal foreign object is present in the vicinity of the primary coil L1. In this manner, the primary side controller 12 determines whether or not a metal foreign object is present based on the difference in the current values of the input current measured in fixed cycles. When determining whether or not the most recent current value is greater than or equal to the second threshold, the determination result may differ depending on external conditions such as the temperature and the shape, type, and size of a metal foreign object. However, the determination result of the primary side controller 12 is not affected by external conditions. More specifically, by using the difference in the current value obtained in fixed detection cycles, the difference in external conditions, such as the temperature and the shape, type, and size of a metal foreign object, can be canceled. Further, determination variations caused by the temperature and the shape, type, and size of a metal foreign object can be decreased.

(2) The input current differs between the standby state, the authentication state, and the charging state. Thus, even when comparing the current value of the input current with the first threshold, which is generated based on a reference current value obtained when the input current is input in a different state, a metal detection error may occur. Thus, the primary side controller 12 of the above embodiment sets the first threshold based on the reference current value obtained in a charging state to detect whether or not a metal foreign object is present. In this manner, the primary side controller 12 compares the current value of the input current obtained in the same state as when the reference current value is obtained. Thus, metal can be detected with further accuracy.

(3) The primary side controller 12 also determines that a metal foreign object is present when the current value is greater than or equal to the second threshold. Thus, the presence of a metal foreign object can be detected more accurately than when using only the current value difference for the determination.

(4) The primary side controller 12 updates the reference current value in fixed cycles. Thus, when the state of the input current or the gap between the primary coil L1 and the secondary coil L2 changes, the current value of the input current can be compared in substantially the same state in correspondence with the change, and a metal foreign object can be detected with further accuracy.

(5) The current value of the input current changes in accordance with the progress in the charging of the battery BA (i.e., charged amount). When the current value of the input current decreases, it can be determined that a fully charged state is near. However, when the charged contactless power reception device 20 is driven at a certain timing, the current value of the input current may increase. In such a case, the current value difference of the input current in the previous detection and the present difference increases. This may cause an erroneous detection. Thus, when the current value of the input current supplied to the oscillation unit 13 decreases in a charging state, the primary side controller 12 changes the charging state first threshold in accordance with the current value. This decreases erroneous detection of a metal foreign object regardless of the charged amount of the battery BA.

(6) The input current measurement unit 11 includes the resistor R1 and the resistor R2, which have different resistances. Input current flows through the resistor R1 when the alternating flux generated by the primary coil L1 does not intersect the secondary coil L2. Input current flows through the resistor R2 when the alternating flux intersects the secondary coil L2. Since the current value of the input current differs between a state in which charging is performed and a state in which charging is not performed, the resistance of the resistor is changed accordingly. Thus, the resistance is increased when the current value of the input current is small, and the resistance is decreased when the current value of the input current is large. This prevents unnecessary power consumption.

(7) Generally, the charge amount of the battery BA changes the charging current. Thus, when the AC current from the secondary coil L2 is converted into DC current and directly supplied to the battery BA, the value of the current flowing to the secondary coil L2 changes in accordance with the charged amount of the battery BA. Further, the current value of the input current flowing to the primary coil L1 also changes in accordance with the current value of the secondary coil L2. Accordingly, the determination of whether a change in the current value of the input current is caused by a metal foreign object or the charge amount of the battery BA may not be possible. Thus, in the present embodiment, DC current is constant-current-controlled so that current having the same current value flows to the secondary coil L2. This allows for elimination of the possibility of the current value of the input current being changed by the charged amount of the battery BA. Thus, when the current value of the input current flowing to the primary coil L1 changes, it can be determined that this is due to metal detection, and erroneous detections can be reduced.

(8) Generally, when the charged amount of the battery BA is close to a full state, the voltage of the battery BA increases and the current value of the charging current decreases. Thus, the load current control unit 23 constant-current-controls the load current so that the current value of the load current becomes lower than the current value of the charging current. This obtains the received current. Thus, metal foreign object detection can be performed while performing charging.

The above embodiment may be modified as described below.

In the above embodiment, the primary side controller 12 determines whether or not the current value of the input current is greater than or equal to the second threshold to detect a metal foreign object. However, the primary side controller 12 may use only the first threshold, which determines the current change amount.

In the above embodiment, the input current measurement unit 11 switches the resistors R1 and R2 in a charging state and a state other than the charging state to change the resistance. However, the resistance may be the same in a charging state and a state other than the charging state.

The primary side controller 12 may determine that a metal foreign object is present when the difference between most recent current value of the input current measured by the input current measurement unit 11 and the current value measured one cycle ahead of the present cycle (reference current value) is greater than or equal to the current value I. The primary side controller 12 may determine that a metal foreign object is present when the difference between the current value measured two cycles ahead of the present cycle (reference current value) and the current value measured one cycle ahead of the present cycle and the difference between the current value measured two cycles ahead of the present cycle (reference current value) and the most recent current value of the input current are both greater than or equal to the predetermined current value I. This allows for a metal foreign object to be determined with further accuracy. In this case, the primary side controller 12 stores each of the current value measured one cycle ahead of the present one and the current value measured two cycles ahead of the present one as the reference current value.

In the above embodiment, the primary side controller 12 determines that a metal foreign object is present when the most recent current value of the input current measured by the input current measurement unit 11 is greater than or equal to the first threshold, which is based on the current value (reference current value) measured one cycle ahead of the present cycle. In a further example, the primary side controller 12 may determine that a metal foreign object is present when the most recent current value is greater than or equal to the first threshold, which is based on the current value measured two cycles ahead of the present cycle, and also greater than or equal to another first threshold, which is based on the current value measured one cycle ahead of the present cycle. This allows for the determination of a metal foreign object to be determined with further accuracy. In this case, the primary side controller 12 stores each of the current value measured one cycle ahead of the present cycle and the current value measured two cycles ahead of the present cycle as the reference current value.

In the above embodiment, when the current value of the input current supplied to the primary coil decreases, the primary side controller 12 changes the charging state first threshold in accordance with the current value. In another example, the primary side controller 12 may receive a control signal notifying the charge amount from the secondary side controller 24 and change the charging state first threshold based on the control signal. More specifically, when the current value of the charging current becomes less than the current value of the load current, the secondary side controller 24 outputs a control signal that changes the first threshold. When receiving the control signal, the primary side controller 12 changes the charging state first threshold based on the control signal or the current value of the input current.

In the above embodiment, the charging current control unit 24 of the contactless power reception device 20 may perform charge control. However, the charging current control unit 24 may be arranged in the contactless power supply device 10, and charge control may be performed at the contactless power supply device 10.

In the above embodiment, metal detection is performed when controlling the load current to be smaller than the charging current. However, the load current value may be a fixed value. When the charging current becomes smaller than the load current, the current value I added to the reference current value may be varied.

The input current measurement unit 11 may measure the input current supplied to the oscillation unit 13 or the coil L1 instead of the input current supplied from the power supply E.

### DESCRIPTION OF THE REFERENCE CHARACTERS

100 . . . contactless charging system, 10 . . . contactless power supply device, 11 . . . input current measurement unit, 12 . . . primary side controller, 13 . . . oscillation unit, 20 . . . contactless power supply device, 21 . . . resonance circuit unit, 22 . . . rectification circuit unit, 23 . . . load current control unit, 24 . . . secondary side controller, 25 . . . charging current measurement unit, BA . . . battery, L1 . . . primary coil, L2 . . . secondary coil

1. A contactless power supply device that supplies power in a contactless manner from a primary coil to a secondary coil, the contactless power supply device comprising:
the primary coil supplied with AC current l to generate alternating flux;
an input current measurement unit that measures a current value of an input current of the primary coil in a charging state during which the alternating flux generated by the primary coil intersects the secondary coil; and
a determination unit that determines that a metal foreign object has been detected when a most recent input current measured by the input current measurement unit in a most recent detection cycle is greater than or equal to a threshold obtained by adding a predetermined current value to a reference current value, which corresponds to a current value of an input current measured by the input current measurement unit in a previous detection cycle.

2. The contactless power supply device according to claim 1, wherein
the threshold is a first threshold;
in a standby state during which the alternating flux generated by the primary coil does not intersect the secondary coil or an authentication state for determining whether or not the alternating flux generated by the primary coil intersects the secondary coil, the determination unit determines detection of a metal foreign object when a most recent current value measured by the input current measurement unit is greater than or equal to a predetermined second threshold; and
in the charging state during which the alternating flux generated by the primary coil intersects the secondary coil, the determination unit determines detection of a metal foreign object when the most recent current value measured by the input current measurement unit is greater than or equal to the first threshold.

3. The contactless power supply device according to claim 1, wherein
the threshold is a first threshold; and
the determination unit determines detection of a metal foreign object when the most recent current measured by the input current measurement unit is greater than or equal to the first threshold or when the most recent current value is greater than or equal to a predetermined second threshold.

4. The contactless power supply device according to claim 1, wherein the determination unit updates the reference current value in fixed cycles.

5. The contactless power supply device according to claim 1, wherein the input current measurement unit includes
a first measurement resistor through which the input current flows when the alternating flux generated by the primary coil does not intersect the secondary coil, and
a second measurement resistor through which the input current flows when the alternating flux generated by the primary coil intersects the secondary coil,
wherein the first and second measurement resistors have difference resistances.

6. The contactless power supply device according to claim 1, wherein
the determination unit holds the current value of the input current measured in a detection cycle ahead by one cycle from the present cycle as the reference current value, and
when the most recent input current is less than the threshold, the determination unit holds the most recent input current as a new reference current value to update the reference current value.

7. A contactless charging system comprising:
a contactless power supply device including a primary coil supplied with AC current to generate alternating flux; and
a contactless power reception device including a secondary coil that intersects the alternating flux generated by the primary coil, a conversion unit that converts AC current, which is supplied from the primary coil via the secondary coil, into DC current, and a load supplied with the DC current converted by the conversion unit, wherein
the contactless power supply device includes
an input current measurement unit that measures a current value of an input current of the primary coil in a charging state during which the alternating flux generated by the primary coil intersects the secondary coil, and
a determination unit that determines that a metal foreign object has been detected when a most recent input current measured by the input current measurement unit in a most recent detection cycle is greater than or equal to a threshold obtained by adding a predetermined current value to a reference current value, which corresponds to a current value of an input current measured by the input current measurement unit in a previous detection cycle, and the contactless power reception device includes
a load current control unit that constant-current-controls a load current converted to DC current by the conversion unit,
a charging current control unit that supplies the load with the load current as charging current, and
a power reception side measurement unit that measures a current value of the charging current, wherein
the load current control unit is configured to constant-current-control the load current so that a current value of the load current becomes lower than the current value of the charging current, and
the determination unit performs a determination when the load current control unit is executing constant current control.

8. The contactless charging system according to claim 7, wherein
when the charging current to the load becomes lower than the load current, the contactless power reception device transmits a signal for notification of such a situation, and
the contactless power supply device varies the predetermined current value when receiving the signal.
